(19) United States
(12) Patent Application Publication
(10) Pub. No.: US 2013/0105402 A1
(43) Pub. Date: May 2, 2013

(54) METHOD FOR CLARIFYING A WINE SEDIMENT

(71) Applicants: Frank Schauz, Oelde (DE); Stefan Pecoroni, Oelde (DE)

(72) Inventors: Frank Schauz, Oelde (DE); Stefan Pecoroni, Oelde (DE)

(73) Assignee: GEA MECHANICAL EQUIPMENT GMBH, OELDE (DE)

(21) Appl. No.: 13/701,845

(22) PCT Filed: Jul. 18, 2011
(86) PCT No.: PCT/EP11/62216

§ 371 Date: Dec. 4, 2012

(30) Foreign Application Priority Data
Jul. 20, 2010 (DE) 10 2010 027 598.0

(51) Int. Cl. B01D 21/01

(52) U.S. Cl. CPC B01D 21/01
USPC 210/730; 210/702

(57) ABSTRACT

A method for clarifying a wine sediment. The method steps include providing a solid-wall worm centrifuge, clarifying the wine sediment in the centrifuge by forming a solid phase and a liquid phase, and fining the sediment by adding a fining agent at one or both of before and during the centrifugal clarification.

### CROSS-REFERENCE TO RELATED APPLICATION

This application is a national stage of International Application PCT/EP2011/062216, filed Jul. 18, 2011, and claims benefit of and priority to German Patent Application No. 10 2010 027 598.0, filed Jul. 20, 2010, the content of which Applications are incorporated by reference herein.

### BACKGROUND AND SUMMARY

The present disclosure relates to a method for clarifying a wine sediment in a solid-wall worm centrifuge by forming a solid phase and a liquid phase.

Large quantities of sediments will occur after fermentation in the production of wine during the production process. The sediments also contain large amounts of yeast in addition to the suspended matter and must components. Sediments are especially turbid matter or suspended matter, mainly yeast, which settles as a deposit in the barrel or tank, especially after the fermentation of wine.

Within the terms of the present disclosure, the sediment shall be the sludge, yeast sediment, which predominantly consists of yeast, is obtained during the first racking, and can be living or dead yeast cells. In addition, the solid substance further consists predominantly of microorganisms, tartar, calcium tartrate, protein, colorants and fractions of the sludge contained in the must, such as berry skins, for example. The quantity of the depositing yeast sludge fluctuates between 2 to 5% of the fermented must. The outer layers mostly consist of dull-brown slimy substances, whereas the middle, bright yellow layer consists of pure yeast and is therefore known as core yeast. Since the sludge is relatively soft, it cannot be removed very well by a clarification process.

The wine is separated from the sediment by racking. In the case of industrial production, the wine is mostly filtered with infusorial earth without having to wait for sedimentation. Whereas the beverage passes through several processing stages, the sediment remaining in the fermentation tank is regarded as a problematic waste product.

Sediments cannot be disposed of through the sewage system because they still contain high fractions of wine, which might especially cause tipping of the biological stage in sewage treatment plants. However, the sediment can be processed by clarification into a solid material or sludge suitable for landfills and so-called yeast wine.

The embodiments of the present disclosure relate to an optimization of a method for the clarification of the sediment.

The present disclosure thus relates to a method for clarifying a wine sediment. The method steps includes providing a solid-wall worm centrifuge, clarifying the wine sediment in the centrifuge by forming a solid phase and a liquid phase, and fining the sediment by adding a fining agent at one or both of before and during the centrifugal clarification.

Accordingly, a fining of the sediment occurs by addition of at least one fining agent before the centrifugal clarification or during the centrifugal processing.

Fining shall be understood in this connection as being the addition of various substances, for example, fining agents, to the sediment, wherein undesirable suspended matter is bonded by the substances by chemical reactions and/or adsorption and will float to the ground, or they can be separated centrifugally as heavy components.

Fining can help achieve better clarification of the liquid phase, so that improved wine quality can be achieved by the optimized method according to the present disclosure.

Embodiments of the present disclosure are discussed herein and in the appended claims.

The liquid phase can, advantageously, be processed without any conditions in terms of time by continuous fining. The sludge additionally obtained by fining, which is the fining sludge, can easily be separated from the liquid during centrifugal clarification.

In accordance with the present disclosure, fining can occur in an advantageous manner by a gelatin-silica sol fining.

In order to counteract excessive fining, it is advantageous, according to the present disclosure, if the addition of gelatin occurs first and the addition of silica sol subsequently.

Other fining agents, in accordance with the present disclosure, can be used as an alternative to gelatin/silica sol. Those are, for example, bentonite, chitosan, casein, isinglass or other animal proteins, gum arabic, polyvinyl pyrrolidone, or PVPP, tannins, or other polyphenols and/or polyamide.

In accordance with the present disclosure, it is advantageous if a determination of the sludge content occurs in the liquid phase after the fining.

In accordance with the present disclosure, a measuring and control device can subsequently decide, on the basis of a predetermined setpoint value, whether the sludge content of the liquid phase meets the requirements for yeast wine, for example. Dosing of the fining agent can occur on the basis of the determined sludge content, for example.

In an advantageous embodiment of method in accordance with the present disclosure, fining can occur in a mixing section before the centrifugal clarification in the solid-wall worm centrifuge. The fining occurring in this embodiment may be separate from the actual clarification in a subsequent clarification step, by which there will be advanced optimization of the clarification of the liquid phase in the case of sediment types which are especially difficult to clarify.

In another embodiment of the method according to the present disclosure, fining can occur by feeding the fining agent into the solid-wall worm centrifuge during the centrifugal clarification. As a result, a more compact configuration of the installation can be achieved with which the method in accordance with the present disclosure will be performed.

In another embodiment according to the present disclosure, fining can be provided by feeding the fining agent into the discharge of the solid-wall worm centrifuge. As a result, a quality improvement can be achieved in sediment types which are difficult to clarify.

The various embodiments according to the present disclosure can advantageously also be combined with one another. For example, in the case of sediment types which are difficult to clarify, which occurs in methods according to the present disclosure, the fining is performed at a product temperature of 8 to 25° C.

In accordance with the present disclosure, the temperature of the gelatin/silica sol solution may, for example, be 35 to 45° C.

In an embodiment of the present disclosure, a solid-wall worm centrifuge is used whose g-value, that is, the maximum centripetal acceleration of the product in the drum as a multiple of gravitational acceleration, is larger than 2700. Embodiments of the present disclosure are advantageous in this regard.

The inlet position of the distributor in the cylindrical area of the drum may be, for example, closer to the conical area than the liquid outlet, but not in the conical area of the drum. This feature, in accordance with the present disclosure, is advantageous.

In an embodiment of the present disclosure, a deep-pond variation or configuration of the drum may be used. That is, the drum diameter is twice as large as the radius on which the solids outlet openings are disposed. Effects of the embodiments of the present disclosure may be increased by the long sedimentation path that can be achieved in this manner.

Other aspects of the present disclosure will become apparent from the following descriptions when considered in conjunction with the accompanying drawings.

### BRIEF DESCRIPTION OF THE DRAWINGS

FIG. 1 shows a schematic diagram of an installation with a solid-wall worm centrifuge and an upstream mixing stage for a method for clarifying sediments, in accordance with the present disclosure.

FIG. 2 shows a diagram including an embodiment of method steps using the installation of FIG. 1.

FIG. 3 shows a schematic diagram of an installation with a solid-wall worm centrifuge with a feed line for fining agents, in accordance with the present disclosure.

FIG. 4 shows a diagram including an embodiment of method steps using the installation of FIG. 3.

### DETAILED DESCRIPTION

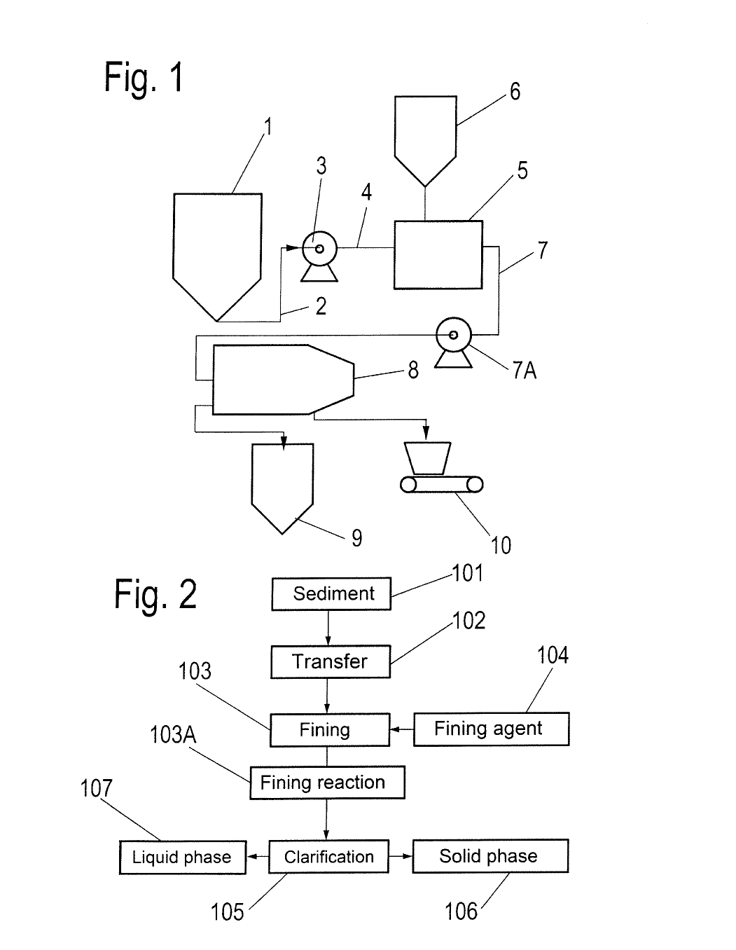

FIG. 1 shows the schematic configuration of an installation or a processing stage for performing a method in accordance with the present disclosure for clarifying sediments.

Sediments can be supplied to the installation in a collective manner, for example, and can be treated separately from the processing process of wine processing. They can also be discharged directly from a fermentation tank, for example, and be processed in an additional processing stage.

A feed tank 1 is provided upstream of the installation, which feed tank 1 has a shape, for example, in form of an upper cylindrical one and a bottom conical one.

The sediment to be processed is filled into the feed tank, for example, consisting of yeast, solid must components, precipitated polymer natural substances and tartar, which form a suspension together with the remaining liquid components. The sediment is discharged, for example, from a fermentation tank (not shown) after the racking of the wine, or it is supplied separately from smaller wine cellerages and filled into the feed tank 1.

The feed tank 1 is connected, for example, via a line 2 with a pump 3 in the bottom region of the feed tank 1, which may be at the lowermost point of the line 2 connected to the feed tank 1 which is conical at the bottom. The sediment is extracted by suction from the feed tank 1 and supplied via the line 4 to a mixing section 5.

Mixing of the sediment with a fining agent occurs in the mixing section 5. The fining agent is supplied to the mixing section 5 from the storage tank 6. The fining process is discussed below in more detail. Following the mixing of the fining agent to the sediment, the mixture is transferred via line 7 and an optional pump 7A to a solid-wall worm centrifuge 8. The optional pump 7A allows, advantageously, for example, controlling the flow rate of the sediment/refining agent mixture.

Clarification of the sediment occurs in the solid-wall worm centrifuge 8 into a clarified liquid phase, which liquid phase is transferred to a storage tank 9, for example, and into a solid phase with the separated fining agent, which solid phase is removed to a refuse dump via a conveyor belt 10.

The clarified liquid phase can also be subjected to further process steps, in accordance with the present disclosure, as an alternative to the storage tank 9.

FIG. 2 shows an embodiment for a possible sequence of a method in accordance with the present disclosure for clarifying sediments in an installation according to FIG. 1.

The sediment 101 is supplied directly from a fermentation process or from the feed tank 1 to the installation.

This is followed by a transfer 102 of the sediment to the mixing section 5 with the help of the pump 3. The fining reaction 103 occurs here, that is, the mixing of one or several fining agents 104 to the sediment 101.

The desired chemical reaction and/or physical effect occurs here by the contact of the fining agent with the components of the sediment.

Subsequently, the sediment/fining agent mixture is guided into the solid-wall worm centrifuge 8. The processing of the sediment into a solid phase 106 for dumping and a liquid phase or fluid phase 107 by centrifugal clarification 105 occurs here.

Finally, the two phases will be discharged separately.

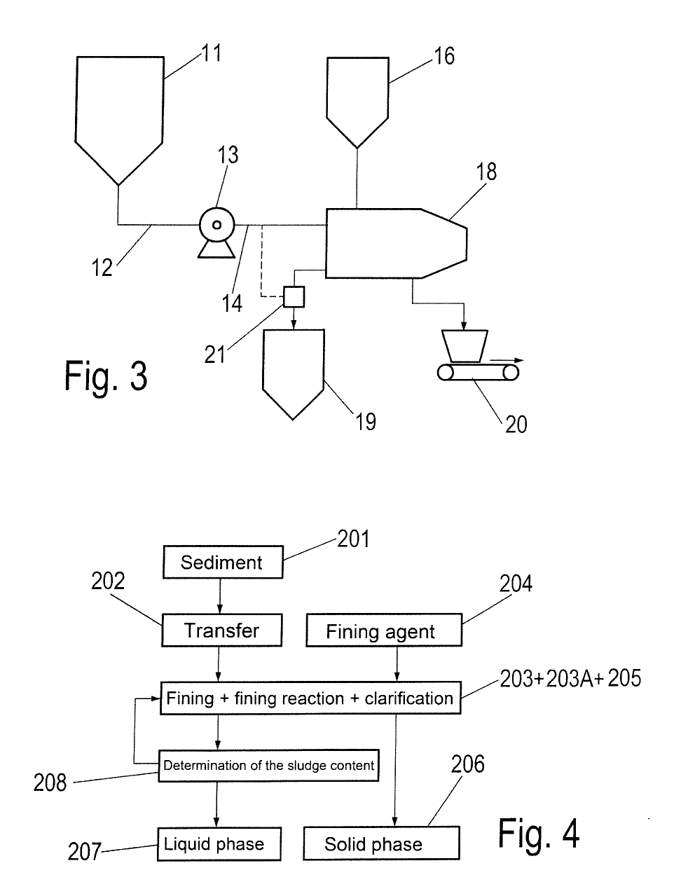

FIG. 3 shows the configuration of an embodiment of an installation for the clarification of sediments in accordance with the present disclosure.

The sediment is guided from a feed tank 11 via lines 12 and 14 and a pump 13 directly into a solid-wall worm centrifuge 18. The solid-wall worm centrifuge 18 is connected via a feed line with a storage tank 16 for the fining agent.

A fining agent, in accordance with the present disclosure, can be introduced directly from said storage tank 16 into the solid-wall worm centrifuge 18. The solid-wall worm centrifuge 18 assumes both the tasks of the mixing of the fining agent with the sediment and also the clarification of the sediment in the solid phase, including the separation of the fining agent, and the liquid phase. The liquid phase can additionally be processed by further process steps, in accordance with the present disclosure, or it can be collected as a so-called yeast wine in the storage tank 19. The solid phase can be transferred to a refuse dump via a conveyor belt 20, for example.

The addition of fining agent can, according to the present disclosure, advantageously occur by determining the sludge content of the clarified liquid phase by a measuring and control unit 21, for example, a turbidimeter. In the event of excessively high sludge content, it can either return the liquid phase to the solid-wall worm centrifuge and/or increase or decrease the addition of fining agent (not shown). The addition of fining agent can occur by way of a dosing lance in an advantageous manner in accordance with the present disclosure.

A further possibility for setting the optimal concentration of fining agent can occur, for example, by determining the sludge content of the clarified liquid phase, for example, by an optical measuring apparatus, and by subsequent control of the sediment flow in the solid-wall worm centrifuge, are in accordance with the present disclosure.

FIG. 4 shows a schematic sequence of another embodiment for a method in accordance with the present disclosure of an installation according to FIG. 3.

A transfer 202 of the sediment 201 occurs at first, for example, from the feed tank 11 directly to the solid-wall worm centrifuge 18.

The fining 203, that is, the supply of fining agent 204, the fining reaction 203A of the fining agent with the solids and the centrifugal clarification 205 of the sediment into a solid phase, including the separated fining agent, and a liquid phase occur in the solid-wall worm centrifuge 18.

This is followed by a discharge of the solid phase 206 and the liquid phase 207 from the solid-wall worm centrifuge 18.

A determination of the sludge content 208 can, for example, occur between the clarification 205 and the discharge of the liquid phase 207, in accordance with the present disclosure.

In another embodiment within the scope of the present disclosure, (not shown), the supply of fining agent can occur to the distributor section, or advantageously, to a region after the distributor between the distributor and the liquid discharge, into the solid-wall worm centrifuge 18.

The distributor can, for example, be provided with mixing elements in order to enable thorough mixing of the fining agent with the sediment, in accordance with the present disclosure.

The introduction of the fining agent behind the distributor is, for example, advantageous because heavier solids have already been separated. As a result, a partial preliminary clarification already occurs in the distributor region, so that less fining agent is required for the clarification of the liquid phase of the sediment after the distributor in the solid-wall worm centrifuge 18 and optimal thorough mixing is ensured at the same time.

In this embodiment of the clarification in accordance with the present disclosure, a solid-wall worm centrifuge 18 with a worm is used which comprises thoroughly mixing segments. Such worms with thoroughly mixing segments in the distributor section are known for example from WO 02/38278 and DE 10 2005 061 461 A1.

The fining agent includes, for example, a combination of gelatin and silica sol, in accordance with the present disclosure.

The method step of fining is discussed below by way of example on the basis of the use, for example, of gelatin-silica sol fining of wine in accordance with the present disclosure.

Gelatin is usually produced by hydrolysis of the collagen of skins, bones and rinds of larger slaughtered animals, and it is a proteic substance. Gelatin is a mixture of partly hydrolysed proteins and peptides, α-spirals, β-peptides and -spirals, γ-peptides and -spirals, and collagen fragments. Acid hydrolyzed gelatin is strongly positively charged in wine, basic hydrolyzed gelatin, however, is charged only very weak in wine. The gelatin causes a decrease both in condensed polyphenols and also tanning substances. It further produces a clearing of the shade, wherein the loss of the actual colorants, the anthocyanins, is only a few percent. Finally, gelatin also allows removing taints and bad flavors at least partly from the wine.

Silica sols are hydrous colloidal silicic acid solutions. They contain non-interlaced spherical particles of amorphous silicic acid.

The determination of the optimal concentration of fining agent can be determined by preliminary fining tests in glass cylinders, wherein the evaluation of the clarification can be made visually for example.

The fining, that is, the clarification of sediment by gelatin, occurs by the discharge of differently charged particles. The undesirable colloids in the sediment, from must, yeast or chemical changes in the wine during fermentation, are generally negatively charged as a result of the ionization of the acid group, whereas the gelatin particles in the wine are positively charged. As a result of the opposite charging, an association of the sludge substances and the fining agent occurs, thereby achieving an agglomeration or aggregation with subsequent flocculation.

The addition of gelatin can occur at first and subsequently to that of the silicic acid in an advantageous way in accordance with the present disclosure. The wine colloids are precipitated first and the excess gelatin will subsequently be removed from the solution by precipitation after the addition of silica sol.

Alternatively, in accordance with the present disclosure silica sol can be added at first and subsequently gelatin. Other fining processes can occur in the mixing section as an alternative or in addition to the described gelatin fining, in accordance with the present disclosure.

In the case of sediment, there is usually a bottom threshold for the solid content of at least 30% by volume, or, for example, 40 to 60% by volume, with the solid typically containing a fraction of 10 to 12% of rather soft solids which are difficult to separate.

In accordance with the present disclosure, in such a sediment with 10 to 12% by volume of soft solids, for example, 5 to 15 g/hL of gelatin, for example, 10 g/hL, hectolitres, will, for example, be added at first and 25 to 75 ml/hL, for example, 50 ml/hL of silica sol.

After the fining and clarification, a liquid phase clarified in this manner will contain approximately 0.2% by volume of soft solids, for example.

The processing of sediments in accordance with the embodiments of the present disclosure, may be arranged as a continuous process.

In a further embodiment within the scope of the present disclosure, (not shown), the supply of fining agent can occur in such a way that the fining agent is added to a line which supplies the sediment to the solid-wall worm centrifuge.

The line can be the feed pipe 2, 12 of the solid-wall worm centrifuge 8, 18, in accordance with the present disclosure. This line 2, 12 may, for example, comprises means for mixing the fining agent with the sediment.

In accordance with the present disclosure, the addition of the fining agent occurs, in an embodiment, in the region of a distributor of the solid-wall worm centrifuge 8, 18. Installed devices, such as projections, for example, are arranged or formed on or in the distributor for the advantageous intensification of the mixing process, so that a virtually homogeneous distribution of the fining agent in the sediment will be achieved.

In addition to the feed pipe 2, 12, the feeding can also, in accordance with the present disclosure, occur by a separate second feed line into the distribution region of the solid-wall worm centrifuge 8, 18.

In accordance with the present disclosure, clarification was improved by 50% or more depending on performance in a test with dosing of gelatin, 5 to 8 g/hL, by a dosing pipe in the feed pipe, that is, by adding the fining agent of gelatin directly into the separating space of a decanting drum.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A method for clarifying a wine sediment, the method steps comprising:
providing a solid-wall worm centrifuge;
clarifying the wine sediment in the centrifuge by forming a solid phase and a liquid phase; and
fining the sediment by adding a fining agent at one or both of before and during the centrifugal clarification.

2. The method according to claim 1, wherein the fining of the sediment is performed in a continuous process.

3. The method according to claim 1, wherein the fining of the sediment occurs by a mixing of the sediment and the fining agent.

4. The method according to claim 1, wherein the fining comprises includes at least the addition of a gelatin-silica sol.

5. The method according to claim 1, wherein the fining is performed at a product temperature of 8 to 25° C.

6. The method according to claim 4, wherein the addition of the gelatin-silica sol includes adding the gelatin first and the silica sol subsequently.

7. The method according to claim 1, wherein after the fining a determination of a sludge content occurs in one of the liquid phase and a partly clarified sediment.

8. The method according to claim 1, wherein the fining occurs in a mixing section of the centrifuge before the centrifugal clarification in the centrifuge.

9. The method according to claim 1, wherein the fining occurs by feeding the fining agent into the solid-wall worm centrifuge during the centrifugal clarification.

10. The method according to claim 7, wherein a dosing of the fining agent occurs on a basis of one of the sludge content of the liquid phase and the partly clarified sediment.

11. The method according to claim 7, wherein a control of the solid-wall worm centrifuge occurs on a basis of one of the sludge content of the liquid phase and the partly clarified sediment.
